(19) United States
(12) Patent Application Publication
(10) Pub. No.: US 2015/0064071 A1
(43) Pub. Date: Mar. 5, 2015

(54) Disposable Module For Device For Synthesizing Radioisotopes And Process For Manufacturing Said Module

(71) Applicant: Ion Beam Applications S.A., Louvain-la-Neuve (BE)

(72) Inventors: Bernard Lambert, Leesburg, VA (US); Michel Guyette, Saint-Servais (BE); Christophe Sauvage, Landenne (BE)

(73) Assignee: Ion Beam Applications S.A., Louvain-la-Neuve (BE)

(21) Appl. No.: 14/389,505

(22) PCT Filed: Mar. 29, 2013
(86) PCT No.: PCT/EP2013/056841

§ 371 Date: Sep. 30, 2014

(30) Foreign Application Priority Data
Mar. 30, 2012 (BE) 2012/0220

(51) Int. Cl. B01J 4/00; B32B 37/12; B32B 38/06

(52) U.S. Cl. CPC B01J 4/00; B32B 38/06; B32B 37/12
USPC 422/159; 29/428; 156/219

(57) ABSTRACT

The present invention relates to a disposable module (100) for use in a device (300) for synthesizing radiopharmaceutical products starting with chemical reagents, said disposable module (100) comprising:
a supporting plate (101) comprising rigid connection means (114) to at least one flask of chemical reagents (102, 103, 104, 105) in solution in a solvent, and a reactor (106);
interface means (115) with a fixed module of said synthesis device (300), in contact with or integrated into said supporting plate (101), said interface means comprising at least one valve (V1-V8) and/or at least one fluid inlet (E1, E2) and/or at least one fluid outlet (O1, O2, O3);
at least one conduit (1-20) connected to said at least one valve (V1-V8) or to said at least one fluid inlet (E1, E2) or to said at least one fluid outlet (O1, O2, O3),
   characterized in that at least one of said conduits (1-20) is integrated into the body of the disposable module (100).

### TECHNICAL FIELD

The present invention relates to a disposable module for a device for synthesizing radioisotopes and to a method for manufacturing said module.

### DESCRIPTION OF THE STATE OF THE ART

Positron emission tomography is a medical imaging technique giving the possibility of viewing the metabolic activity of an organ subsequent to injection of a radioactive tracer, the biological properties of which are known in this organ. One of the most used tracers in nuclear medicine is 18F-fluoro-deoxy-D-glucose abbreviated as [18F]-FDG. This tracer similar to glucose will accumulate in tissues which consume large amounts of sugar like cancer cells, the heart or the brain. The synthesis of [18-F]-FDG is described in the document of Hamacher et al. J. Nucl. Med. 27, 235-238 (1986).

Several automated devices for synthesizing radioactive tracers have been developed. Such a synthesis device is advantageously positioned in a shielding cell.

A device marketed by the applicant under the name of Synthera® is described in document U.S. Pat. No. 7,235,216. This device comprises a fixed module and a disposable module which is positioned on the fixed module.

The fixed module comprises a processor and an interface for the disposable module. The interface of the fixed module is provided with rotary actuators and fluidic connectors leaving the interface and comprises a structure for positioning in an ejectable way a disposable module on said interface so that the rotary actuators and the fluidic connectors may be inserted into the disposable module.

The disposable module comprises:
an interface capable of positioning itself against the interface of the fixed module;
two-way and three-way valves which may be actuated by said actuators of the fixed module;
fluidic connectors capable of being connected with the fluidic connectors of the fixed module;
a plate supporting flasks of reagents and a reactor, each of the flasks being connected to a valve through a flexible pipe and several valves being connected to said reactor through a flexible pipe.

The processor of the fixed module controls the fluid flow rates as well as the opening and the closing of the valves so as to carry out the different steps for the synthesis reaction of the radiopharmaceutical tracer. Once the radiopharmaceutical product is obtained, the latter is transferred into a container by passing through purification cartridges.

Advantageously, the Synthera® is positioned in a shielding cell comprising a container provided with a hatch located at the front of the fixed module and under the disposable module, so as to be able to collect the disposable module when the latter is ejected at the end of the synthesis.

The Synthera® is relatively compact, and several Synthera® devices may be inserted into a same shielding cell. The Synthera® has the advantage of not requiring any human intervention for removing the disposable module once the synthesis of the radiopharmaceutical tracer has completed. Nevertheless, the disposable module of such a device requires a particular assembly of flexible tubes. These flexible tubes are assembled manually on the plate and the customer has to check that each of the tubes is properly attached. Human errors during the positioning of the tubes are always possible.

Further, the area of the supporting plate is relatively compact (14×5 cm) and comprises locations reserved for flasks of reagents as well as for purification cartridges, leaving not very much room for the positioning of the fluidic connection means for the tubes. Certain tubes may have ends close to each other and may be subject to certain tensile stresses which may cause dislodging of the tube. Certain tubes may also bend upon assembling and cause poor flow of the liquid.

The flasks of reagents are sealed by a septum in rubber and maintained on the supporting plate by attachment means. The supporting plate comprises a movable support on which are positioned metal needles connected to the flexible tubes, each of the needles being positioned under a flask of reagents. Before the synthesis, the movable support is actuated so as to insert the needles into the septum of the flasks of reagents. In order to allow proper insertion of the needles into the flasks, the septa of the flasks have reduced thickness, which may sometimes cause an evaporation of certain volatile solvents. Also, when the movable support is actuated, it happens that flasks are dislodged from their attachment means. Microfluidic devices for the synthesis of radiopharmaceutical products were designed for the purpose of producing very small amounts of radiopharmaceutical products, for applications in scientific research. These devices allow the handling of microliters of solutions concentrated with reagents for productions of radiopharmaceutical products, the activity of which does not exceed 100 mCi. Such a device is described in document WO2007041486. This device is intended to produce small doses of radiopharmaceutical products and comprises a plate of 20×20×4 mm, 25×25×5 mm, 7×7×3 mm or 30×30×6 mm into which are integrated:
a network of microfluidic channels, i.e. a network of channels with a cross-section of at least less than 1 mm and;
a cylindrical reactor, for which the ratio of the diameter over the height is greater than 3, the height being comprised between 25 and 1,000 μm, the diameter being comprised between 1 and 20 mm.

This device comprises valves positioned in proximity to the inlets and outlets of the reactor. For producing 18FDG, the reactor is heated to temperatures ranging from 60 to 75°. Overpressures may occur in the reactor during the reaction, due to the small volume of the reactor and to the requirement of closing all the valves for maintaining the liquid in the reactor, which may cause leaks at one or several valves of the reactor. In order to avoid losses of liquids, additional valves or double valves have to be used, which complicates the making of the device.

On the other hand, the reactor is included in the plate; its height is of the order of the diameter of the microfluidic channels and is located in a same plane with the microfluidic channels. The inlets and outlets of the reactor are located on the cylindrical portion of the reactor. The arrangement of the reactor and of the microfluidic channels in the plate as well as the dimensions of the reactor, do not allow good homogenization of the reaction mixture. Several solutions to this problem are proposed in document WO2007041486, nevertheless, the latter complicate the making of the plate. Therefore there is a need for designing a disposable module not having the drawbacks of the aforementioned devices.

Advantageously, such a disposable module has to be able to be inserted on existing fixed modules.

It is also necessary to produce a method for manufacturing disposable modules which is faster and more reliable.

### SUMMARY OF THE INVENTION

The present invention relates to a disposable module for use in a device for the synthesis of radiopharmaceutical products starting with chemical reagents according to any of the appended claims. In particular, this is a disposable module comprising:
a supporting plate comprising rigid means for connecting to at least one flask of chemical reagents in solution in a solvent, and a reactor;
interface means with a fixed module of said synthesis device, in contact with or integrated into said supporting plate, said interface means comprising at least one valve and/or at least one fluid inlet and/or at least one outlet for fluids;
at least one conduit connected to said at least one valve or to said at least one fluid inlet or to said at least one outlet of fluids,
   characterized in that at least one of said conduits is integrated into the body of the disposable module.

In a preferred embodiment of the module, the interface means appear as (i.e. consist in): an interface plate comprising said at least one valve, said at least one fluid inlet and said at least one outlet of fluids and in contact with said supporting plate, characterized in that at least one of said conduits is integrated into said supporting plate and/or into said interface plate.

Preferably, the totality of said conduits are integrated into the body of the disposable module, or—in the case of the shape according to the previous paragraph—into said supporting plate and/or into said interface plate.

According to an embodiment, the connection between the supporting plate and the interface plate is achieved by side wings secured with the supporting plate, and attached to the interface plate by clips.

The integration of conduits into the supporting plate and/or into the interface plate in particular gives the possibility of avoiding the use of flexible tubes for connecting the flasks, the reactor, the fluid inlets and the fluid outlets with the valves, which considerably reduces the risks of confusion, errors during the mounting of the module, the risk of leaks and of disconnecting the tubes.

Advantageously, said rigid connecting means appear in the form of at least one needle molded with a supporting plate, the flasks to be connected being closed by means of a septum.

According to preferred embodiments of the invention, the disposable module includes at least one, or any suitable combination of the following features:
the rigid connecting means are molded with said supporting plate, or said supporting plate is overmolded on at least one metal needle;
the disposable module comprises said at least one flask of chemical reagents in solution in a solvent;
the disposable module comprises:
   conduits arranged so as to allow transfer of said chemical reagents towards said reactor;
   a conduit arranged so as to allow the introduction of a gas flow into said reactor;
   a conduit arranged so as to apply vacuum in the reactor;
   a conduit arranged for allowing the discharge of the product obtained in said reactor;
said supporting plate comprises attachment means for said at least one flask;
said reactor is in a chemically inert plastic material in the presence of solutions encountered in the synthesis of radiopharmaceutical products and thermoresistant to temperatures above 150° C., preferably said plastic material is an ethylene-norbornene copolymer, the glassy transition temperature is above 150° C.

Another aspect of the invention relates to a method for manufacturing a disposable module for use in a device for the synthesis of radiopharmaceutical products, said method comprising a step for assembling (adhesively bonding) a film, a sheet or a plate onto a substantially planar disposable module plate and provided with grooves, so as to hermetically cover said grooves so as to form conduits or conduit portions able to transfer chemical reagents, gases or products.

Advantageously, the method of the invention comprises the following steps:
i) adhesively bonding a film, a sheet or a plate on a supporting plate comprising:
   a first face provided with grooves and with first fluidic connection means connected to said grooves;
   a face perpendicular to said first face, said perpendicular face comprising second fluidic connection means in communication with said grooves,
so as to hermetically cover said grooves;
ii) adhesively bonding a film, a sheet or a plate on an interface plate comprising:
   a face provided with grooves and;
   fluidic connection means positioned so as to be able to connect to said second fluidic connection means of said supporting plate;
so as to cover said grooves of said interface plate;
iii) hermetically assembling said supporting plate with said interface plate, so as to connect said fluidic connection means of said interface plate with said second fluidic connection means of said supporting plate.

Preferably, said hermetically assembling step is carried out by inserting a gasket between said supporting plate and said interface plate.

According to another preferred embodiment of the invention, the method comprises the following steps:
i) embossing a first plate comprising:
   a first face provided with grooves and first fluidic connection means connected to said grooves;
   a face perpendicular to said first face, said perpendicular face comprising second fluidic connection means in communication with said grooves,
and a second plate comprising:
   a first face provided with grooves and with first fluidic connection means connected to said grooves;
   a face perpendicular to said first face, said perpendicular face comprising second fluidic connection means in communication with said grooves,
so as to form a supporting plate, said first face of said first plate being put into contact with said first face of said second plate, said grooves of said first plate and of said second plate being positioned so as not to come into contact with each other;
ii) adhesively bonding a film, a sheet or a plate on an interface plate comprising:
   a face provided with grooves and;
   fluidic connection means positioned so as to be able to be connected to said second fluidic connection means of said supporting plate;
so as to cover said grooves of said interface plate;
iii) hermetically assembling said supporting plate with said interface plate, so as to connect said fluidic connection means of said interface plate with said second fluidic connection means of said supporting plate. Advantageously, said supporting plate and said interface plate are in ethylene-norbornene copolymer, the glassy transition temperature of which is above 150° C. and in that said films, sheets or plates covering said grooves are in polypropylene.

A third aspect of the invention relates to a device for the synthesis of radiopharmaceutical products characterized in that it comprises a disposable module according to the invention. Advantageously, the disposable module of the invention is made by means of the method of the invention.

### SHORT DESCRIPTION OF THE DRAWINGS

FIG. 1 shows a view of the disposable module according to the present invention;

FIG. 2 shows a view of the upper portion of the disposable module according to the present invention;

FIG. 3 shows a view of the low portion of the disposable module according to the present invention;

FIG. 4 shows a view of the rear of the interface plate of the disposable module according to the present invention.

FIG. 5 shows a view of a synthesis device comprising the disposable module according to the present invention

FIG. 6 shows a view of the upper portion of the disposable module according to a second embodiment of the invention.

FIG. 7 shows a view of a supporting plate and of an interface plate of a disposable module according to a third embodiment of the present invention.

FIG. 8 shows a diagram of a first embodiment of a method for manufacturing a disposable module according to the present invention.

FIG. 9 shows a diagram of a second embodiment of a method for manufacturing a disposable module according to the present invention.

FIG. 10 shows a global view of a disposable module according to the present invention.

FIG. 11 shows the portions of the supporting plate of the module shown in FIG. 10.

FIG. 12 shows another view of the supporting plate of the module shown in FIG. 10.

FIG. 13 shows the portions of the interface plate of the module shown in FIG. 10.

The figures are not drawn to scale.

### DETAILED DESCRIPTION OF THE INVENTION

The present invention was described in terms of specific embodiments which are illustrative of the invention and which should not be interpreted in a limiting way. More generally, one skilled in the art will appreciate that the present invention is not limited by what has been particularly illustrated and/or described below.

The use of the verbs <<comprise>>, <<include>>, <<consist of>>, <<be provided with>>, or any other alternative, as well as their respective conjugations, does not exclude the presence of elements other than those indicated.

The use of the article <<one>>, <<the>> preceding an element does not exclude the presence of a plurality of such elements.

According to a first aspect, the present invention relates to a disposable module 100 for a macrofluidic device for automated synthesis of a radioactive tracer.

Preferably, the disposable module comprises:
at least one flask of chemical reagents 102, 103, 104, 105 in solution in a solvent;
a reactor 106;
fluid transfer means comprising a conduit and a valve for opening or closing said conduit and;
a supporting plate 101 supporting said reactor 106 and said at least one flask.

A macrofluidic device for synthesis is defined as a synthesis device for which at least the reactor may contain volumes of liquids greater than 1 ml. Preferably, the flasks of reagents are also able to contain volumes of liquids of more than 1 ml. Still more preferably, the section of the conduits is greater than 1 mm in diameter.

The disposable module 100 is characterized in that at least one conduit is integrated into the body of the disposable module 100. Preferably, the whole of all the conduits is integrated into the body of the disposable module.

The use of flexible pipes as fluid transfer means is thus suppressed.

Preferably, the body of said disposable module 100 is formed with said supporting plate 101 and with a second interface plate 115 perpendicular to said supporting plate 101.

Preferably, said supporting plate 101 is attached against the interface plate 115 by an attachment means.

Preferably, a sealing gasket is comprised between said supporting plate and said interface plate 115.

Preferably, the disposable module 100 comprises:
a first fluid transfer means being arranged so as to allow transfer of said chemical reagents from said flask to said reactor;
a second fluid transfer means being arranged so as to allow the introduction of a gas flow into said reactor and;
a third fluid transfer means being arranged so as to allow the discharge of the product obtained in said reactor.

Preferably, said supporting plate 101 comprises attachment means 107 for said at least one so-called flask.

Preferably, said supporting plate 101 comprises fluidic connection means 114 for the flasks of reagents and fluidic connection means 114′ for the reactor.

Preferably, said at least one flask of reagents is sealed with a rubber septum and said fluid transfer means comprise a pointed fluidic connection means 114 able to pierce through said septum, said fluidic connection means being in a molded plastic material with said supporting plate. The flasks may thus be attached by hand with the required pressure, which gives the possibility of sealing the flasks with thicker septa and avoiding possible evaporations of liquid. With this configuration, the problems of dislodgement of the flasks from their attachment means are also avoided.

Preferably, the supporting plate 101 comprises a tube 108 immersed in said reactor, said plunger tube 108 being connected to said third fluid transfer means in order to discharge the product of the reaction.

Preferably, the plunger tube is molded against the wall of the reactor.

Preferably, a portion of said disposable module 100 is made in polypropylene of medical grade (for example marketed under the name of . . . ) and another portion of said disposable module is made in an ethylene-norbornene copolymer marketed under the name of Topas®. These materials are approved by the FDA (Food and Drug Administration) for producing devices for production of radiopharmaceuticals.

According to a first embodiment of the invention, said reactor 106 is attached on the supporting plate by an attachment means. According to a second embodiment of the invention, the reactor is welded against the body of the supporting plate 101. According to a third embodiment of the invention, a first portion of the reactor is molded with the supporting plate 101 and a second portion of the reactor is welded against the first portion of the reactor. The reactor 106 is preferably made of a plastic material transparent to visible light and chemically inert in the presence of the solutions encountered in the synthesis of radiopharmaceutical products such as for example solutions comprising acetonitrile, acids or bases, and thermoresistant to temperatures above 150° C.

Preferably, the reactor is in ethylene-norbornene copolymer, the glassy transition temperature of which is above 150° C. Such copolymers are marketed by TOPAS Advanced Polymers GmbH, under the names of series 6015 and 6017 having a glassy transition temperature of 160° C. and 178° C. respectively, the glassy transition temperature of the ethylene-norbornene copolymer being proportional to the norbornene level in the copolymer. This material has the advantage of not including any silicon or other metals such as aluminium or boron, which in the state of trace amounts may have an influence on the yield of the nucleophilic substitution reaction as this is described in document WO2011084763.

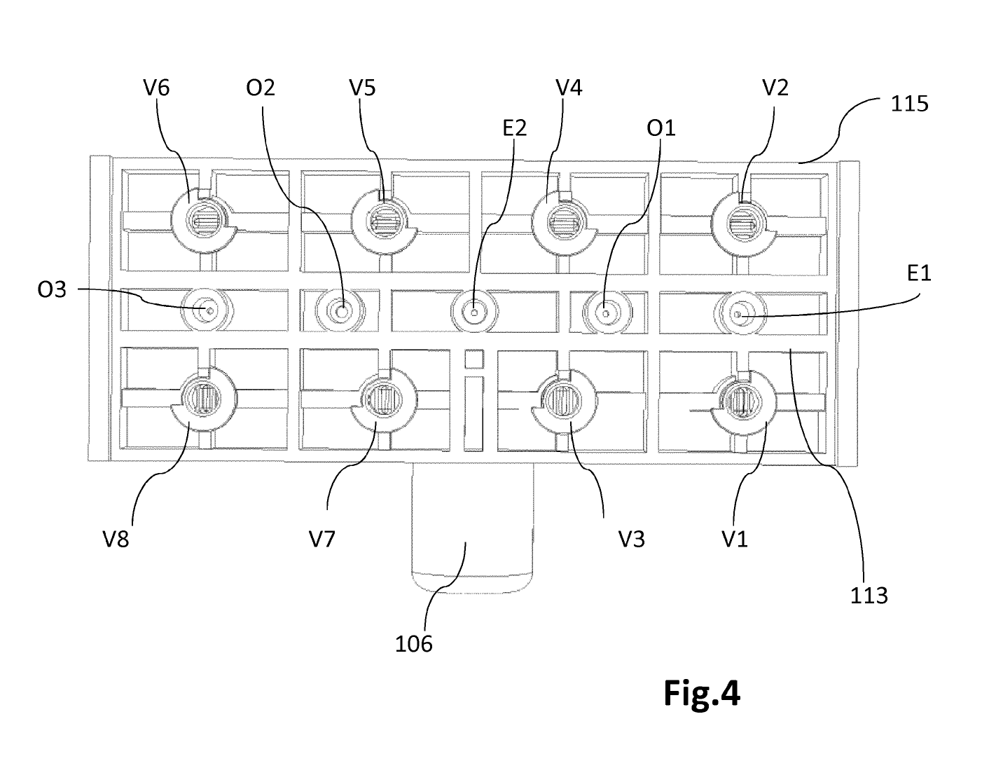

Preferably, the interface plate 115 of the disposable module 100 comprises an interface 113 (FIG. 4) for connecting to a fixed module 200 of a synthesis device 300 for radiopharmaceutical products such as for example the fixed module of a Synthera® marketed by the applicant and described in more detail in document U.S. Pat. No. 7,235,216 incorporated by reference. Preferably, said interface 113 comprises inlets and outlets for fluids.

### First Exemplary Embodiment of the Invention

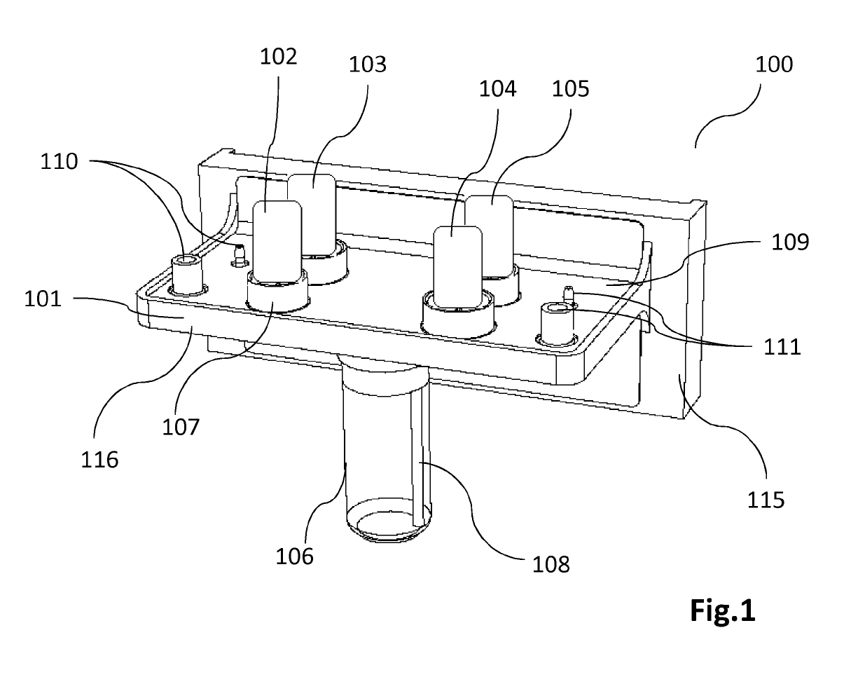

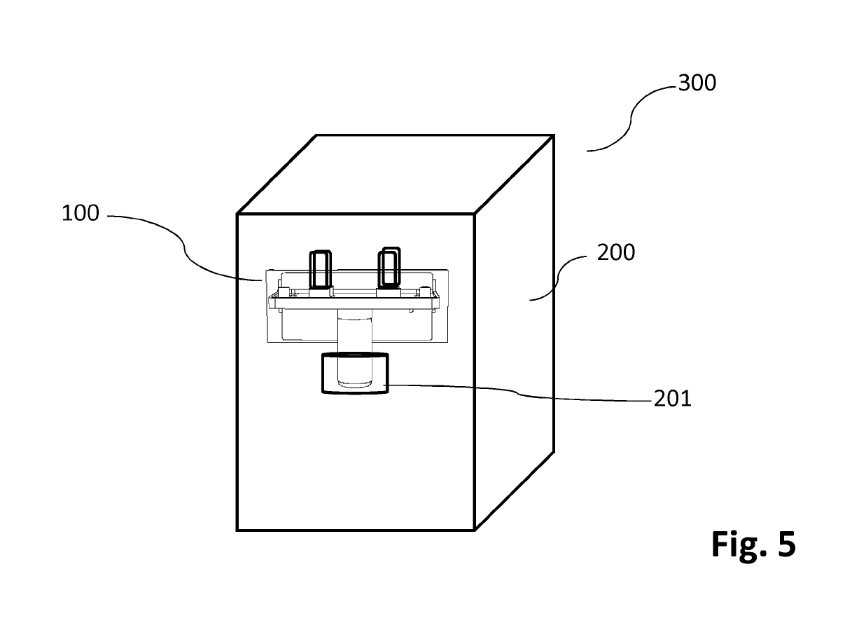

FIGS. 1 to 5 relate to a non-limiting example of a disposable module intended for the synthesis of ¹⁸F-fluorodeoxyglucose (18[F]-FDG). The synthesis of 18[F]-FDG is not a limitation of the use of the disposable module, other radiopharmaceutical tracers may be synthesized by adapting the disposable module, for example by changing the arrangement of the transfer means, the number and the contents of the flasks of chemical reagents.

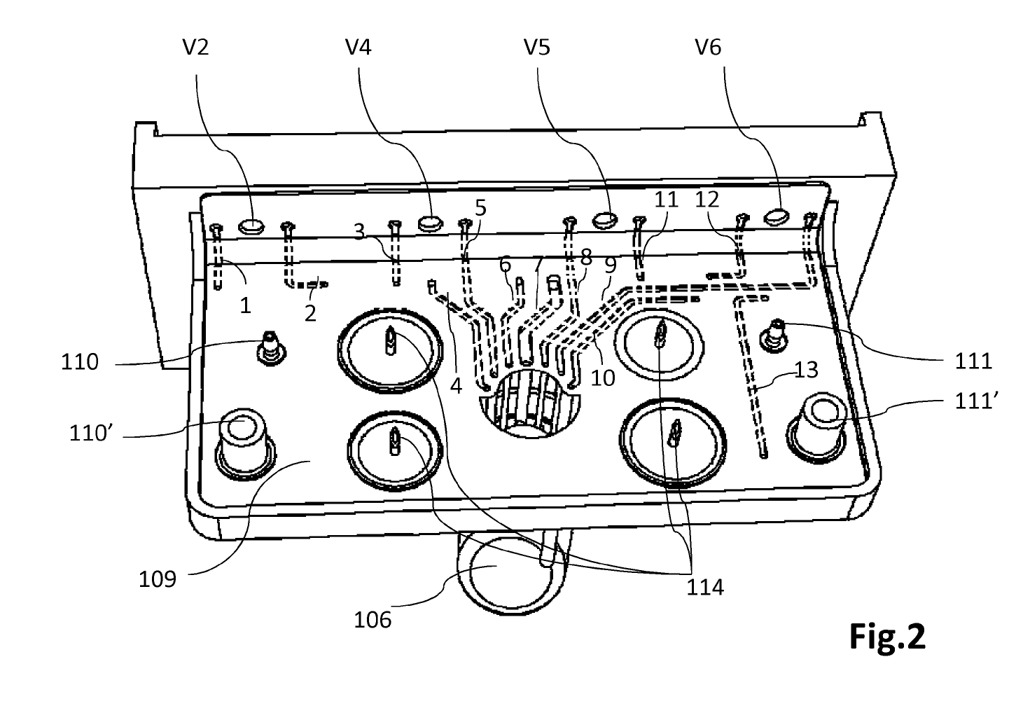

According to a particular embodiment of the present invention, the body of the disposable module 100 comprises a supporting plate 101 and a second interface plate 115 substantially perpendicular to said supporting plate 101, as illustrated in FIGS. 1 to 3. The supporting plate 101 comprises a first face 109, illustrated in FIGS. 1 and 2, comprising:
a first flask of reagent 102 comprising an acetonitrile solution of 4,7,13,16,21,24-hexaoxa-1,10-diazabicyclo[8.8.8]hexacosane more known under the name of Kryptofix 2.2.2.;
a second flask of reagents 103 comprising a solution in acetonitrile of β-D-mannopyranose 1,3,4,6-tetra-O-acetate 2-O-trifluoromethanesulfonate, 1,3,4,6-tetra-O-acetyl-2-O-trifluoromethanesulfonyl-β-D-manno-pyranose, more known under the name of mannose triflate;
a third flask of reagents 105 comprising NaOH in solution in water;
a fourth flask 104 containing water.

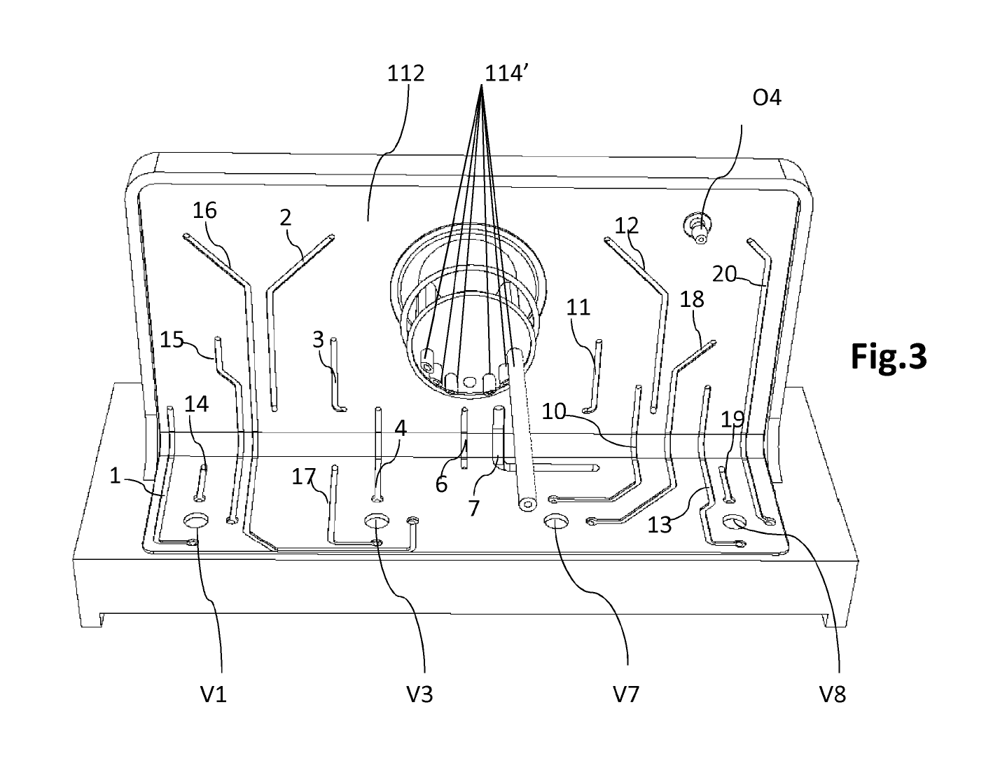

The flasks 102, 103, 104 and 105 are preferably sealed with a rubber septum. The first face 109 also comprises fluidic connection means 114, for example needles capable of piercing the septum of said flasks. The first face 109 also comprises first inlet 110 and outlet 110′ fluidic connection means for an F-18 extraction cartridge containing an anion exchanger resin, preferably a QMA Waters cartridge (not shown for the sake of clarity of the drawing), and the second inlet 111 and outlet 111′ fluidic connection means for an 18F-FDG purification cartridge (not shown for the sake of clarity of the drawing). The supporting plate 101 comprises a second face 112, illustrated in FIG. 3, on which is attached a reactor 106 (not shown in FIG. 3 for the sake of clarity of the drawing), either via an attachment means or via a weld or via a molding with the plate or via any other attachment method. The second face 112 further comprises a liquid outlet O4 for discharging the 18F-FDG obtained at the end of the synthesis.

The interface plate 115 comprises a front face 116 supporting said supporting plate 101 and a rear face 113 being used as interface for attaching the disposable module 100 on a fixed module as for example described in document U.S. Pat. No. 7,235,216.

FIG. 2 illustrates a view of the disposable module 100 centered on said first face 109 of the supporting plate and a portion of the front face 116 of the interface plate 115. Two-way valves V2, V4, V5 and V6 are located in an upper portion of the interface plate 115.

FIG. 3 illustrates a view of the disposable module centered on the second face 112 of the supporting plate and a lower portion of the interface plate 115. Three-way valves V1, V3, V7, V8 are located in a lower portion of the interface plate 115.

FIG. 4 illustrates a rear view of the disposable module, and more particularly of the rear portion 113 of the interface plate 115, being used as an interface with a fixed module.

The rear portion 113 of the interface plate 115 comprises:
an inlet E1 for the fluid flowing out of a target for production of radioisotopes, the fluid generally being water enriched with O-18 (¹⁸O)) containing F-18;
a first outlet O1 of liquid for discharging water enriched with O-18;
an inlet E2 of inert gas such as for example helium;
an outlet O2 for applying vacuum
an outlet O3 for discharging wastes from the reaction.

FIG. 4 also shows the rear portion of the valves V1, V2, V3, V4, V5, V6, V7 and V8, included in the interface plate 115, each of these valves comprising a housing for valve actuators for a fixed module 200.

The disposable module comprises a plurality of channels entirely integrated into the body of the disposable module:
a first channel 14 connecting the inlet E1 to the valve V1;
a second channel 1 crossing the supporting plate and connecting the valve V1 to the valve V2;
a third channel 2 connecting the first reagent flask 102 containing Kryptofix to the valve V2
a fourth channel 15 connecting the valve V1 by means of an inlet fluidic connection 110 of the 18F capture cartridge;
a fifth channel 16 connecting the outlet fluidic connection means 110′ of the 18F capture cartridge to the valve V3;
a sixth channel 17 connecting the valve V3 to the outlet O1;
a seventh channel 4 connecting the valve V3 to the reactor 106;
an eighth channel 3 connecting the second flask of reagents 103 containing mannose triflate to the valve V4;
a ninth channel 5 connecting the valve V4 to the reactor 106;
a tenth channel 6 connecting the gas inlet E2 to the reactor 106;
an eleventh channel 7 connecting the reactor 106 to the outlet O2 for the vacuum;
a twelfth channel 11 connecting the third flask 105 containing NaOH to the valve V5;
a thirteenth channel 8 connecting the valve V5 to the reactor 106;
a fourteenth channel 12 connecting the fourth flask 104 containing water to the valve V6;
a fifteenth channel 9 connecting the valve V6 to the reactor 106;
a sixteenth channel 10 connecting the plunger tube 108 in the reactor 106 to the valve V7;
a seventeenth channel 18 connecting the valve V7 to the inlet fluidic connection means 111 of the FDG purification cartridge;
an eighteenth channel 20 connecting the outlet fluidic connection means 111′ of the FDG purification cartridge to the valve V8;
a nineteenth channel 19 connecting the valve V8 to the outlet O3 for discharging the waste from the reaction and;
a twentieth channel 13 connecting the valve V8 to the outlet O4 for discharging the FDG.

### Second Exemplary Embodiment of the Invention

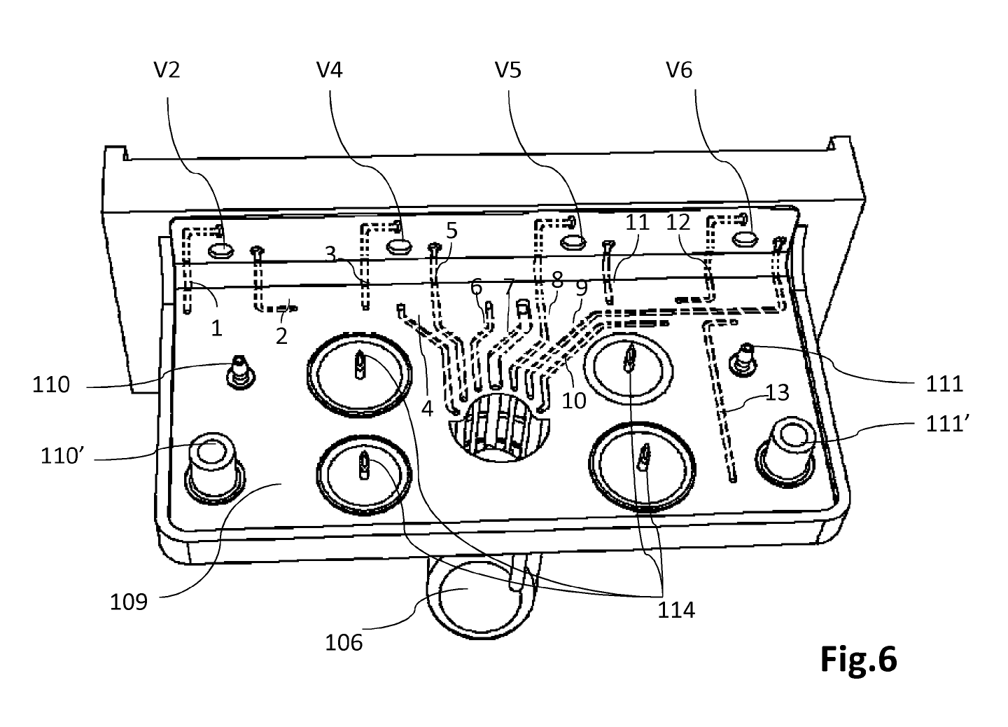

FIG. 6 shows a second exemplary embodiment of the invention comprising all the features of the first example and wherein:
the connection between the second channel 1 forms an angle of 90° with the valve V2 and the connection between the valve V2 and the third channel 2;
the connection between the eighth channel 3 forms an angle of 90° with the valve V4 and the connection between the valve V4 and the ninth channel 5;
the connection between the twelfth channel 11 forms an angle of 90° with the valve V5 and the connection between the valve V5 and the thirteenth channel 8 and;
the connection between the fifteenth channel 9 forms an angle of 90° with the valve V6 and the connection between the valve V6 and the fourteenth channel 12.

The valves V2, V4, V5 and V6 in this case are three-way valves. All the valves of the disposable module are thus three-way valves, which make the disposable module easier and less costly to manufacture.

### Third Exemplary Embodiment of the Invention

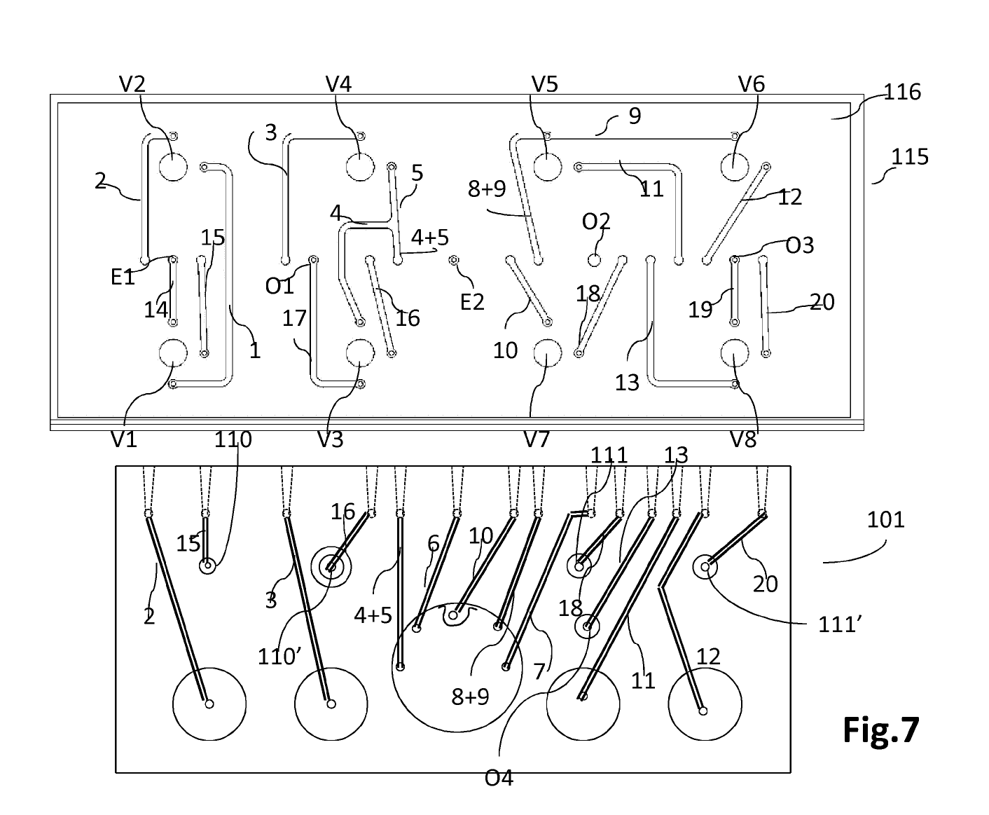

FIG. 7 shows a third exemplary embodiment of the invention comprising all the features of the first and of the second example but wherein the channel network is changed so as to avoid the intersection of the channels in the supporting plate 101.

Also, the interface plate 115 is changed so that the channels 4 and 5 join up in order to form a common channel 4+5, and so that the channel 9 joins up with channel 8 in order to form a common channel 8+9. With this joining of the inlet channels of reagents it is possible to reduce the number of channels directed towards the reactor 106, which simplifies the supporting plate 101.

According to a second aspect, the present invention relates to a method for manufacturing a disposable module 100 for an automated macrofluidic device for synthesizing a radioactive tracer as described above.

The method comprises a step for assembling (by adhesively bonding or welding for example) a film, a sheet or a plate on a substantially planar disposable module plate and provided with grooves, so as to hermetically cover by means of a film or a plate said grooves in order to form conduits or conduit portions able to transfer chemical reagents, gases or products. According to a first embodiment of the method, the method for manufacturing the disposable module is carried out in the following way:

In a first step, a film, a sheet or a plate 400 is assembled onto a supporting plate 101 comprising:
a first face provided with grooves and first fluidic connection means connected to said grooves;
a face perpendicular to said first face, said perpendicular face comprising second fluidic connection means in communication with said grooves,
   so as to hermetically cover said grooves.

In a second step, another film, another sheet or another plate 400′ is assembled onto an interface plate 115 comprising:
a face 116 provided with grooves and;
fluidic connection means positioned so as to be able to connect to said second fluidic connection means of said supporting plate;
   so as to hermetically cover said grooves of the interface plate.

The film, sheet or plate 400′ assembled on the interface plate 115 is either perforated beforehand or pierced after adhesive bonding so that each of the fluidic connection means is de-obstructed.

Preferably, adhesive bonding of the films, sheet or plate on said supporting plate and on said interface plate is carried out by means of a thermal welding method without any solvents, for example a laser welding method, a heating method with ultrasound or a method using heated blades.

In a third step, the supporting plate 101 is assembled with said interface plate 115, so as to connect said fluidic connection means of said interface plate 115 with said second fluidic connection means of said supporting plate 101.

Preferably, a gasket 401 is inserted between the supporting plate 101 and the interface plate 115 during the assembling step.

Preferably, the interface plate 115 comprises an attachment means 403 in which the supporting plate 101 will be fastened with clips or vice versa. The interface plate 115 also comprises locations for valves positioned on the face 113 opposite to the face 116 provided with grooves.

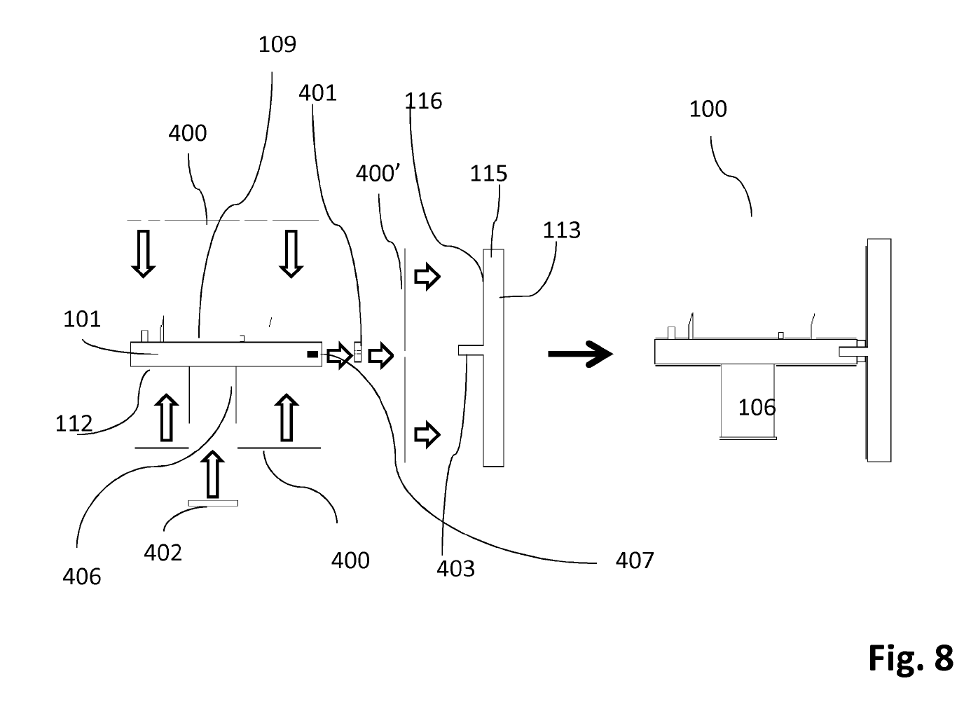

According to an example of the first embodiment of the method, as illustrated in FIG. 8, said supporting plate 101 comprises:
two opposite faces 109, 112 provided with grooves and with first fluidic connection means connected to said grooves;
a face 407 perpendicular to said two opposite faces, said perpendicular face comprising second fluidic connection means in communication with said grooves.

In the first step of the method as described above, a film, a sheet or a plate 400 are assembled on each of the opposite faces 109, 112 provided with grooves and with fluidic connections, so as to hermetically cover said grooves.

Preferably, an open cylindrical portion 406 extends perpendicularly downwards from the supporting plate 101 from its lower surface 112. Preferably, a plunger tube 108 is molded against the wall of the open cylindrical portion 406. In a subsequent step to the assembling of the film, sheet or plate 400 on the lower face 112 of the supporting plate 101, a circular part 402 is welded to the base of the cylindrical portion so as to form a reactor 106.

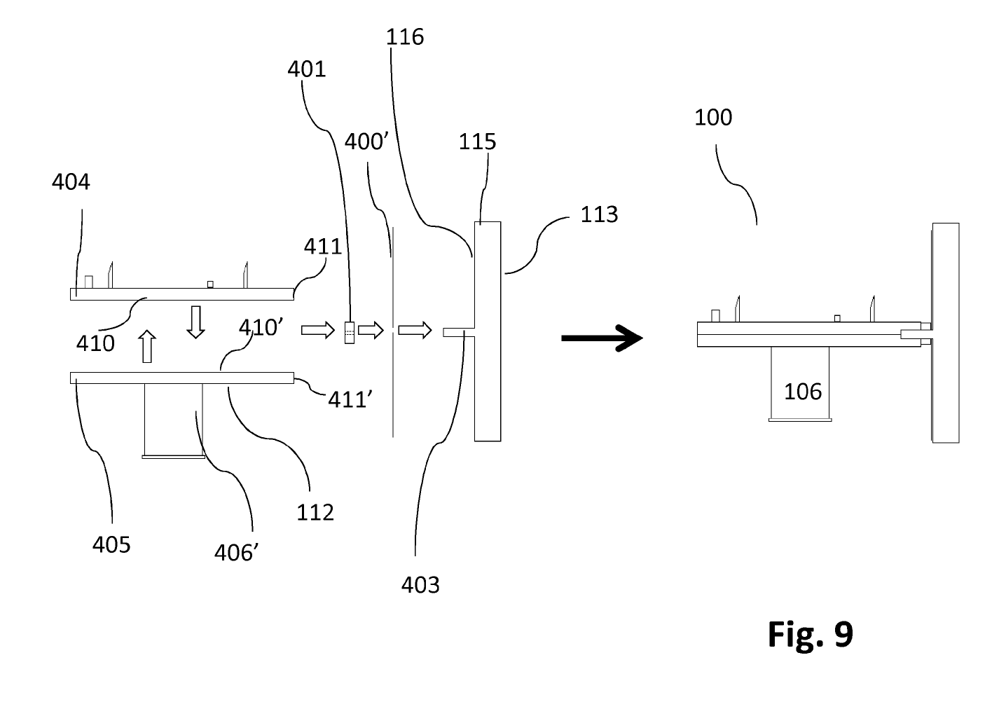

According to a second embodiment of the method illustrated in FIG. 9, the method for manufacturing the disposable module is carried out in the following way:

In a first step, a first plate 404 comprising:
a first face 410 provided with grooves and with first fluidic connection means connected to said grooves;
a face 411 perpendicular to said first face, said perpendicular face comprising second fluidic connection means in communication with said grooves,
   and a second plate 405 comprising:
a first face 410′ provided with grooves and with first fluidic connection means connected to said grooves;
a face 411′ perpendicular to the said first face, said perpendicular face comprising second fluidic connection means in communication with said grooves,
   are embossed so as to form a supporting plate 101, said first face 410 of said first plate 404 being put into contact with said first face 410′ of said second plate 405, said grooves of said first plate 404 and of said second plate 405 being positioned so as not to come into contact with each other. Preferably, the second plate 405 comprises an open cylindrical portion 406′ extending perpendicularly towards the bottom of the plate 405 from the lower surface 112. Preferably, a plunger tube 108 is molded against the wall of the open cylindrical portion 406′. In a preliminary or subsequent step to the step for embossing the first plate 404 with the second plate 405, a circular part 402 is welded to the base of the cylindrical portion so as to form a reactor 106.

In a second step, a film, a sheet or a plate 400′ is assembled to an interface plate 115 comprising:
a face 116 provided with grooves and;
fluidic connection means positioned so as to be able to connect to said second fluidic connection means of said supporting plate;
   so as to hermetically cover said grooves of said interface plate 115.

Preferably, the assembling of the films, sheet or plate 400 on said interface plate 115 is carried out by means of a thermal welding method without any solvents, for example a laser method, a heating method with ultrasound or a method using heated blades.

The film, sheet or plate 400 assembled on the interface plate 115 is either perforated beforehand, or pierced after adhesive bonding so that each of the fluidic connection means is de-obstructed.

In a third step, said supporting plate 101 is assembled with the interface plate 115, so as to connect said fluidic connection means of the interface plate 115 with said second fluidic connection means of said supporting plate 101.

Preferably, a gasket 401 is inserted between the supporting plate 101 and the interface plate 115 during the assembling step.

Preferably, the interface plate comprises an attachment means 403 in which will be fastened the supporting plate 101 with clips or vice versa. The interface plate 115 also comprises valves positioned on the face 113 opposite to the face 116 provided with grooves.

Preferably, independently of the embodiment of the method for manufacturing the disposable module, said supporting plate 101 and said interface plate 115 are in ethylene-norbornene copolymer, the glassy transition temperature of which is above 150° C. and said films, sheets or plate covering said grooves are in polypropylene. According to an embodiment, the supporting plate 101 and the interface plate 115 form a single unit part instead of two separate and assembled parts.

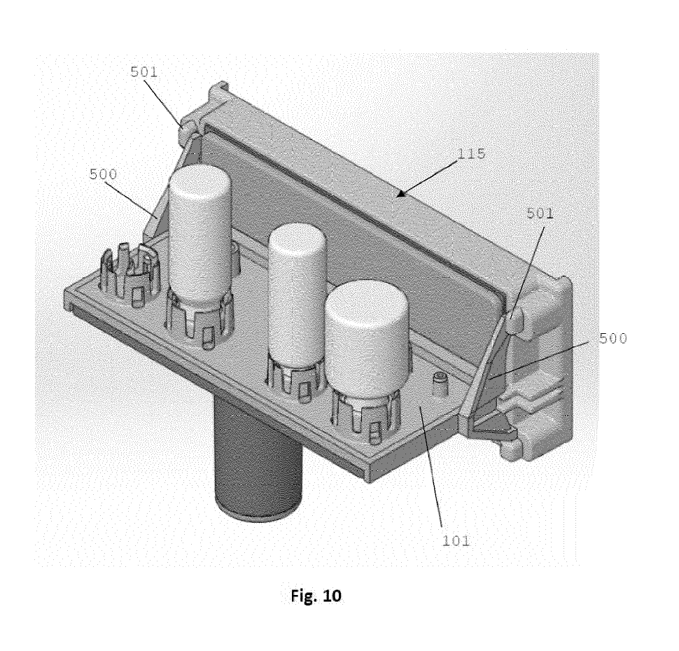

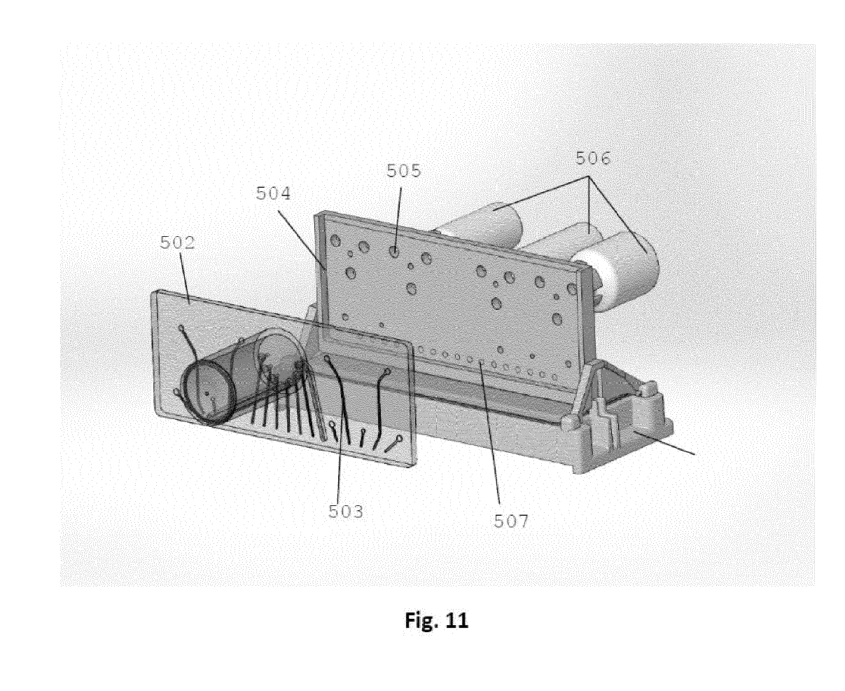

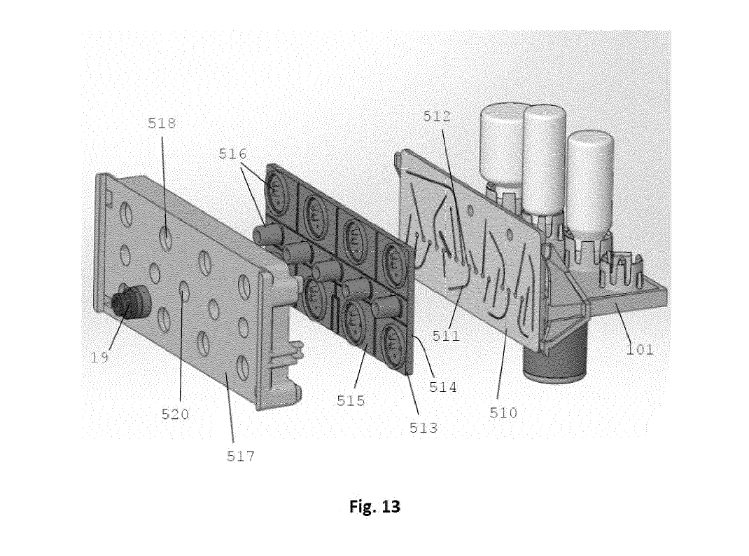

According to another embodiment, the module comprises a supporting plate 101 into which are integrated the interface means such as the valves V1-V8, the fluid inlets E1-E2 and the fluid outlets O1-O3. This embodiment may be achieved by increasing the thickness of the supporting plate with respect to the embodiments described above, so as to house the interface means in a wall of said plate which is perpendicular to the plane of the plate. Another possibility is to provide a supporting plate provided with a central portion comprising rigid connection means 114 to at least one flask of chemical reagents, and the portions located laterally with respect to the central portion but in the same plane as the central portion, the lateral portions being provided with said interface means. In the embodiment illustrated in FIGS. 10-13, the connection between the supporting plate 101 and the interface plate 115 is ensured by side wings 500 secured with the supporting plate, and attached to the interface plate with clips 501.

The supporting plate 101 is assembled from a first plate 502 provided with grooves 503 and a second plate 504 provided with apertures 505 and 506 for connecting to the conduits formed by the grooves 503 after the assembling. The wings 500 are secured with a second plate 504. A first group of apertures 505 are connected to the flasks 506 mounted on the supporting plate. A second group of apertures 507 is connected through the inside of the portion 504 to apertures 508 at the perpendicular face 509 of the second plate 504. Therefore this is an embodiment similar to the one shown in FIG. 9, except that the grooves 503 are all found in one of the two portions (404 and 405 in FIG. 9).

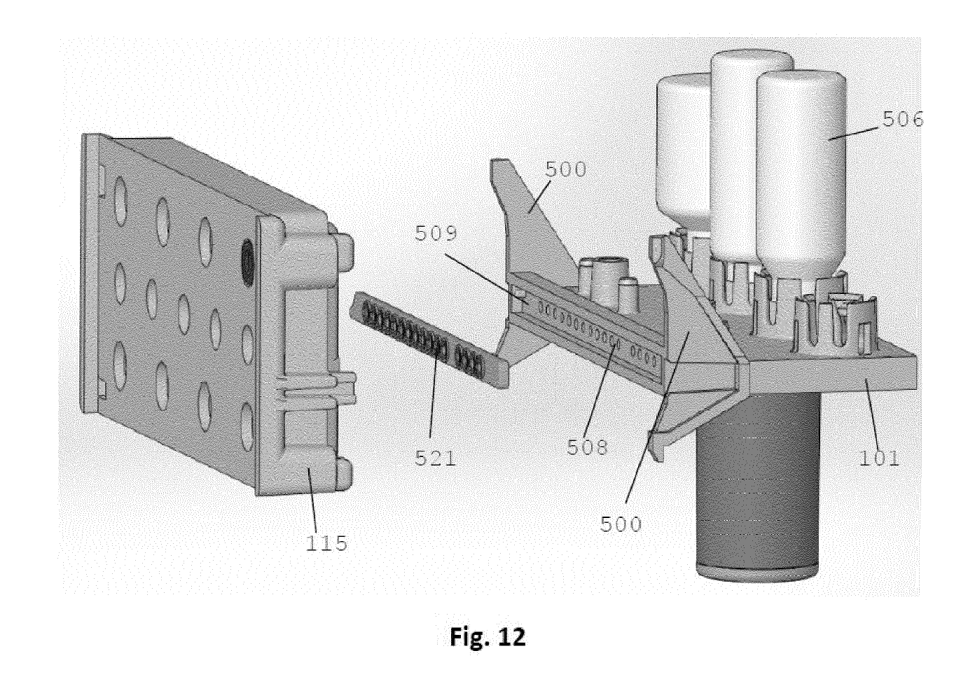

The interface plate 115 is formed by the assembling of three portions:
a plate 510 provided with grooves 511 and with apertures 512 configured so as to connect to the apertures 508 of the supporting plate 101,
a plate 513 comprising a planar face 514 which will be placed against the grooves 511 in order to generate channels, and a face 515 comprising means 516 for connecting valves and fluid inlets or outlets, and
a third plate 517 comprising apertures 518 for housing valves 519 of different types, as well as apertures 520 for fluid inlets or outlets. Sealing means 521 are inserted between both plates 101 and 115 as shown in FIG. 12.

1. A disposable module (100) for use in a device (300) for synthesis of radiopharmaceutical products starting with chemical reagents, said disposable module (100) comprising:
a supporting plate (101) comprising rigid connection means (114) to at least one flask of chemical reagents (102, 103, 104, 105) in solution in a solvent, and a reactor (106);
interface means (115) with a fixed module of said synthesis device (300), in contact with or integrated into said supporting plate (101), said interface means comprising at least one valve (V1-V8) and/or at least one fluid inlet (E1, E2) and/or at least one fluid outlet (O1, O2, O3);
at least one conduit (1-20) connected to said at least one valve (V1-V8) or to said at least one fluid inlet (E1, E2) or to said at least one fluid outlet (O1, O2, O3), wherein at least one of said conduits (1-20) is integrated into the body of the disposable module (100).

2. The disposable module (100) according to claim 1, wherein the interface means appear as an interface plate (115) comprising said at least one valve (V1-V8), said at least one fluid inlet (E1, E2) and said at least one fluid outlet (O1, O2, O3) and in contact with said supporting plate (101), wherein at least one of said conduits (1-20) is integrated into said supporting plate (101) and/or into said interface plate (115).

3. The disposable module according to claim 2, wherein the totality of said conduits (1-20) are integrated into said supporting plate (101) and/or into said interface plate (115).

4. The disposable module according to claim 2, wherein the connection between the supporting plate (101) and the interface plate (115) is carried out by side wings (500) secured with the supporting plate (101), and attached to the interface plate (115) with clips (501).

5. The disposable module according to claim 1, wherein said rigid connection means (114) appear in the form of at least one needle.

6. The disposable module according to claim 1, wherein said rigid connection means are molded with said supporting plate, or said supporting plate is overmolded over at least one metal needle.

7. The disposable module according to claim 1, wherein it comprises said at least one flask of chemical reagents (102, 103, 104, 105) in solution in a solvent.

8. The disposable module according to claim 1, wherein it comprises:
conduits (1, 2, 3, 4, 5, 8, 9, 11, 12, 15, 16) arranged so as to allow transfer of said chemical reagents to said reactor;
a conduit (6) arranged so as to allow the introduction of a gas flow into said reactor;
a conduit (7) arranged so as to apply vacuum in the reactor;
a conduit (10) arranged for allowing the discharge of the product obtained in said reactor.

9. The disposable module according to claim 1, wherein said supporting plate (101) comprises attachment means (107) for said at least one flask.

10. The disposable module according to claim 1, wherein said reactor (106) is in a chemically inert plastic material in the presence of solutions encountered in the synthesis of radiopharmaceutical products and thermoresistant to temperatures above 150° C.

11. The disposable module according to claim 10, wherein said plastic material is an ethylene-norbornene copolymer, the glassy transition temperature of which is above 150° C.

12. (canceled)

13. A method for manufacturing a disposable module for use in a device for synthesis of radiopharmaceutical products, said method comprising a step for assembling a film, a sheet or a plate (400, 404, 405, 504, 400, 513) on a substantially planar disposable module plate (101, 405, 404, 502, 115, 510) and provided with grooves, so as to hermetically cover said grooves in order to form conduits or conduit portions able to transfer chemical reagents, gases or products.

14. The method according to claim 13, wherein it comprises the following steps:
i) assembling a film, a sheet or a plate (400) on a supporting plate (101) comprising:
a first face (109, 112) provided with grooves and with first fluidic connection means (114, 114′, 110, 110′, 111, 111′) connected to said grooves;
a face (407) perpendicular to said first face (109,112), said perpendicular face comprising second fluidic connection means in communication with said grooves, so as to hermetically cover said grooves;
ii) assembling a film, a sheet or a plate (400′) on an interface plate (115) comprising:
a face (116) provided with grooves and;
fluidic connection means positioned so as to be able to connect to said second fluidic connection means of said supporting plate;
so as to cover said grooves of said interface plate (115);
iii) hermetically assembling said supporting plate (101) with said interface plate (115), so as to connect said fluidic connection means of said interface plate (115) with said second fluidic connection means of said supporting plate (101).

15. The method according to claim 14, wherein said hermetic assembling step is carried out by inserting a gasket (401) between said supporting plate (101) and said interface plate (115).

16. The method according to claim 13, comprising the following steps:
i) Embossing a first plate (404) comprising:
a first face (410) provided with grooves and with first fluidic connection means (114, 110, 110′, 111, 111′) connected to said grooves;
a face (411) perpendicular to said first face (410), said perpendicular face (411) comprising second fluidic connection means in communication with said grooves, and a second plate (405) comprising:
a first face (410′) provided with grooves and with first fluidic connection means (114′) connected to said grooves;
a face (411′) perpendicular to said first face (410′), said perpendicular face (411′) comprising second fluidic connection means in communication with said grooves, so as to form a supporting plate (101), said first face (410) of said first plate (404) being put into contact with said first face (410′) of said second plate (405), said grooves of said first plate and of said second plate being positioned so as to not come into contact with each other;
ii) adhesively bonding a film, a sheet or a plate (400′) on an interface plate (115) comprising:
a face (116) provided with grooves and;
fluidic connection means positioned so as to be able to connect to said second fluidic connection means of said supporting plate;
so as to cover said grooves of said interface plate (115);
iii) hermetically assembling said supporting plate (101) with said interface plate (115), so as to connect said fluidic connection means of said interface plate (115) with said second fluidic connection means of said supporting plate (101).

17. The method according to claim 13, wherein said supporting plate (101) and/or said interface plate (115) are in ethylene-norbornene copolymer, the glassy transition temperature of which is above 150° C. and in that said films, sheets or plates covering said grooves are in polypropylene.

18. A device for synthesizing radiopharmaceutical products, the device comprising a disposable module (100) according to claim 1.

19. A disposable module (100) for use in a device (300) for synthesis of radiopharmaceutical products starting with chemical reagents, said disposable module (100) comprising:
a supporting plate (101) comprising rigid connection means (114) to at least one flask of chemical reagents (102, 103, 104, 105) in solution in a solvent, and a reactor (106);
interface means (115) with a fixed module of said synthesis device (300), in contact with or integrated into said supporting plate (101), said interface means comprising at least one valve (V1-V8) and/or at least one fluid inlet (E1, E2) and/or at least one fluid outlet (O1, O2, O3);
at least one conduit (1-20) connected to said at least one valve (V1-V8) or to said at least one fluid inlet (E1, E2) or to said at least one fluid outlet (O1, O2, O3), wherein at least one of said conduits (1-20) is integrated into the body of the disposable module (100),
the disposable module obtained by the method according to claim 13.
